(19) United States
(12) Patent Application Publication
(10) Pub. No.: US 2023/0144005 A1
(43) Pub. Date: May 11, 2023

(54) Bed cover connection device

(71) Applicant: Ningbo Crosstrip Electronic Science Co.,Ltd, Cixi City (CN)

(72) Inventors: Lei QIU, Cixi City (CN); Lei CHEN, Cixi City (CN)

(21) Appl. No.: 17/530,429

(22) Filed: Nov. 18, 2021

(30) Foreign Application Priority Data
Nov. 10, 2021 (CN) 202111324678.1

(51) Int. Cl. B60J 7/19; E05B 15/00

(52) U.S. Cl. CPC B60J 7/198; E05B 15/0053

(57) ABSTRACT

The invention discloses a bed cover connection device for pickup truck, wherein includes a sidebar lock system connected to two sidebars, a large rear bar lock system connected to the rear bar and multiple intermediate node blocks, the sidebar locking system includes a sidebar lock base, the sidebar lock base has a locking cavity, and there are two large rear bar lock systems, the two large rear-bar lock systems are set corresponding to the two side-bar lock systems, the large rear-bar lock system includes a rear-bar lock block and a lock connection shaft, the rear-bar lock block is connected to the rear bar, the lock connection shaft passes through the rear-bar lock block. The device in this invention can pull the lock out of the lock cavity to open the rear bar by setting up a wire rope, and multiple intermediate node blocks, which separate the wire rope into multiple segments, are set up to facilitate the user to pull the wire rope.

### TECHNICAL FIELD

This invention is relevant to auto parts field, especially about the bed cover connection device.

### BACKGROUND TECHNOLOGY

Pickup car, also known as the sedan truck, has a cargo hopper for loading goods; since the truck's cargo hopper is open, in order to avoid the rain from wetting the goods inside in rainy and snowy weather, people designed a bed cover and installed the cover on the cargo hopper of pickup, so as to cover the goods inside the hopper and avoid the goods from getting wet by rain.

However, the existing connection device uses a hidden structure of wire rope, which is not convenient to pull.

### About the Invention

In view of this, the purpose of this invention is to provide a bed cover connection device, by changing the wire rope from hidden to open to facilitate pulling.

Thus the invention use the following method:
A bed cover connection device for pickup truck includes a sidebar lock system which is connected to two sidebars, a large rear bar lock system which is connected to the rear bar and multiple intermediate node blocks.
The sidebar locking, system includes a sidebar lock base, the sidebar lock base is provided with a locking, cavity.
There are two large rear bar lock systems, the two large rear-bar lock systems are set corresponding to the two side-bar lock systems, the large rear-bar lock system includes a rear-bar lock block and a lock connection shaft, the rear-bar lock block is connected to the rear bar, the lock connection shaft passes through the rear-bar lock block, one end of the lock connection shaft is connected with a lock matches the lock cavity, the other end of the lock connection shaft is connected with a connector for connecting the wire rope, the lock connection shaft is provided with a spring, one end of the spring is connected to the lock, the other end of the spring is connected to the rear bar lock block.
The interior of the rear bar lock block is a step hole structure, the spring comes to the step hole.
A plurality of intermediate node blocks are all connected to the rear bar, the wire rope passes through the intermediate node block, both ends of the wire rope are respectively connected to two connectors.
By setting the wire rope, users can pull the wire rope to pull the lock out of the lock cavity, so as to open the rear bar, by setting up a plurality of intermediate node blocks to separate the wire rope into several segments, so as to facilitate the pulling the wire rope.
The sidebar lock base includes a slide-in groove, the rear bar lock block includes a block which is matches the slide-in groove, the block is a cylinder. The slide-in groove is a “√” shape and the slide-in, groove is provided with, a limited protrusion at the end near rear-bar lock block, which is used to stop the block, by setting the slide-in groove and block, the block can slide into the slip-in groove and snap in with it, when the user closes the lid to lock, the block of the rear-bar locking block first falls into the slide-in groove on the first fixing block, the lock rotates at a certain angle with the cylindrical block as the lid is gradually closed, so that, the lock is squeezed by the lock cavity and compressed into the inner ladder hole, ejected, and then snapped into the lock cavity to complete the closing operation of the car cover, the connector is provided with an mounting hole for connecting the wire rope.
The bed cover connection device includes two aluminum pressed wires, the two aluminum pressed wires are located between the two connector which is corresponding to the two ends of the wire rope respectively, the aluminum pressed wire is used to connect with the wire rope. By setting the mounting holes and aluminum pressed wire, the wire rope and the lock shaft can be secured well to ensure the force strength.

The lock connection shaft includes a threaded segment and a connection segment, the lock (3401) is connected to the threaded segment by thread, the connection segment is provided with a fixed connector. The lock and the lock connection shaft are fixed through threads, which not only ensures the strength of the connection of the lock but also facilitates the replacement of the lock.

There are two intermediate node blocks, the intermediate node block is provided with a cross-wire hole for passing through the wire rope, and by setting two intermediate node blocks, the wire rope can be separated into three segments, which is convenient for users to pull.

The outer upper surface of the locking cavity is oblique, the inner upper surface of the locking cavity is flat, the end of the lock is curved. The outer side of the lock cavity is designed as a bevel, so that it can produce a squeeze force on the lock when the lock touches the outer wall of the lock cavity, so as to facilitate the locking of the bed cover. The inner side of the lock cavity is designed as a plane can effectively prevent the lock from sliding out, when the user pulls the wire rope to open the bonnet, the lock is pulled back into the ladder hole, and the user can lift the lid up to complete the cover opening operation.

The bed cover connection device includes a sidebar anti-tilting structure which is arranged above the sidebar, the sidebar anti-tilting structure is used to prevent the sidebar from tilting, the sidebar anti-tilting structure is comprised of the bottom bulge point on the sidebar, which can form a fulcrum with the hard, contact of the sidebar to prevent the sidebar from tilting.

The beneficial effect of the invention is: firstly, by separating the wire rope into three segments, one of the sections can be pulled to open the lock, so as to facilitate user's operation, then, setting the sidebar anti-tilting structure to form a fulcrum with the hard contact of the sidebar to prevent the sidebar from tilting.

### DESCRIPTION OF DRAWINGS

FIG. 1 is a structure illustration 1 of this invention;

FIG. 2 is a structure illustration 2 of this invention;

FIG. 3 is a partial enlarged diagram of part A in FIG. 2;

FIG. 4 is a structure illustration of cylindrical lock constriction in this invention;

FIG. 5 is a structure illustration 1 of rear bar lock system in this invention

FIG. 6 is a structure illustration 2 of rear bar lock system in this invention

FIG. 7 is a diagram of the connection of the anti-tilting structure of the sidebar in this invention

2—sidebar lock system; 21—sidebar lock base; 2101—slide-in groove; 2102—lock cavity; 22—sidebar; 2201—sidebar anti-tilting structure: 3—large rear bar lock system; 31—rear-bar locking block; 3101—block; 32—lock connection shaft; 3201—connector; 3202—threaded segment; 3203—connection segment; 33—aluminum pressed wire; 3401—loc; 3501—wire rope; 36—intermediate node blocks; 37—spring; 4—Rear Bar.

### The Concrete Method to Carry Out

The invention is further explained in combination with attached drawings and specific embodiments below. It should be noted here that the following descriptions of the embodiment is intended to help understand the present invention rather than constitute a limitation of this invention. The functional details disclosed by the invention are used only to describe the example embodiment of the invention. However, the invention can also be embodied in many alternative forms, and should not be understood as the limitation of the invention in the embodiment described in the present invention.

It should also be noted that the terms used in the present invention only to describe a particular embodiment, not to limit the example embodiment of the invention. If the terms “includes”, “includes”, “contains” and/or “contains” are used in the invention, they specify only the existence of the declared features, integers, steps, operations, units and/or components, and does not exclude the existence or addition of one or more other features, quantities, steps, operations, units, components and/or their combinations.

It should also be noted that in some alternative embodiments, functions/actions may appear in a different order than those shown in the drawings. For example, functions/movements involved in two diagrams that presented in succession can actually be executed concurrently, or sometimes in reverse order.

It should also be noted that specific details provided in the following description is to facilitate a complete understanding of the sample embodiment. However, ordinary technical personnel in the art should understand that sample embodiments can be implemented without these specific details. For example, a system can be shown in the diagram to avoid making the examples unclear with unnecessary details. While in other instances, well-known processes, structures, and techniques may not be illustrated in unnecessary detail to avoid making the sample implementation unclear.

### Embodiment 1

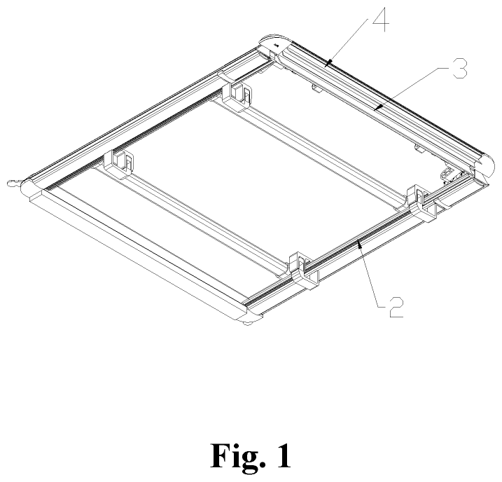

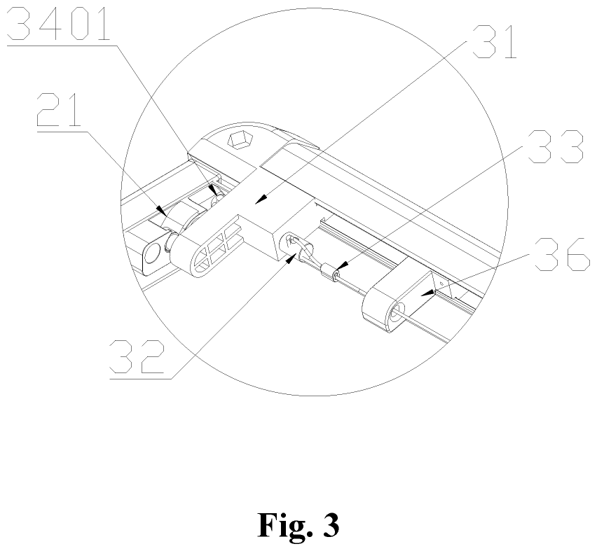

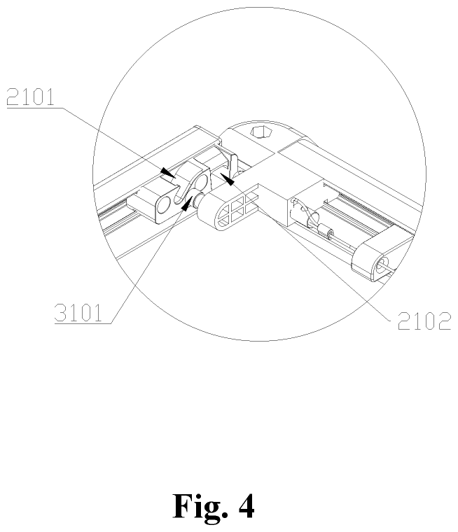

As is seen from FIGS. 1 to 4, a bed cover connection device for pickup truck includes a sidebar lock system 2 which is connected to two sidebars 22, a large rear bar lock system 3 which is connected to the rear bar 4 and multiple intermediate node blocks 36.

The sidebar locking system 2 includes a sidebar lock base 21, the sidebar lock base 21 is provided with a locking cavity 2102.

There are two large rear bar lock systems 3, the two large rear-bar lock systems 3 are set corresponding to the two side-bar lock systems 2, the large rear-bar lock system 3 includes a rear-bar lock block 31 and a lock connection shaft 32, the rear-bar lock block 31 is connected to the rear bar 4, the lock connection shaft 32 passes through the rear-bar lock block 31, one end of the lock connection shaft 32 is connected with a lock 3401 matches the lock cavity 2102, the other end of the lock connection shaft 32 is connected with a connector 3201 for connecting the wire rope 3501, the lock connection shaft 132 is provided with a spring 37, one end of the spring 37 is connected to the lock 3401, the other end of the spring 37 is connected to the rear bar lock block 31.

The interior of the rear bar lock block 31 is a step hole structure, the spring 37 comes to the step hole.

A plurality of intermediate node blocks 36 are all connected to the rear bar 4, the wire rope 3501 passes through the intermediate node block 36, both ends of the wire rope 3501 are respectively connected to two connectors 3201.

By setting the wire rope 3501, users can pull the wire rope 3501 to pull the lock 3401 out of the lock cavity 2102, so as to open the rear bar 4; by setting up a plurality of intermediate node blocks 36 to separate the wire rope 3501 into several segments, so as to facilitate the user to pull the wire rope 3501.

### Embodiment 2

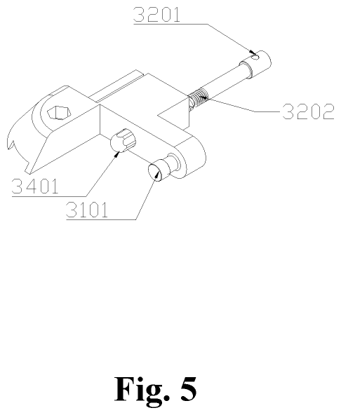

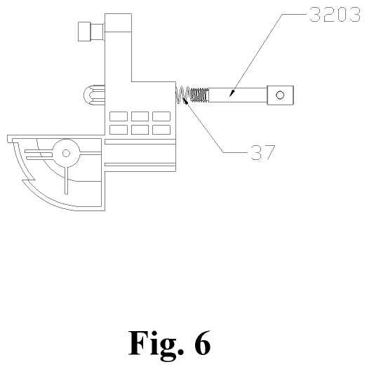

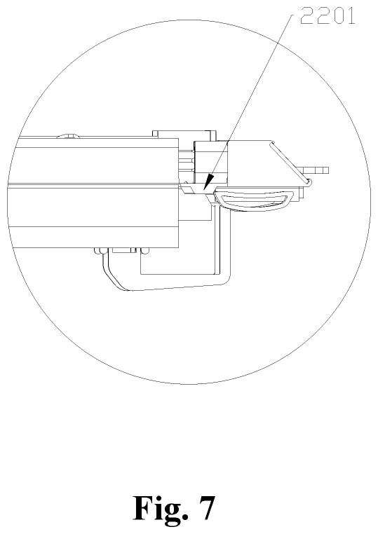

As is seen from FIGS. 1 to 7, a bed cover connection device for pickup truck includes a sidebar lock system 2 which is connected to two sidebars 22, a large rear bar lock system 3 which is connected to the rear bar 4 and multiple intermediate node blocks 36.

The sidebar locking system 2 includes a sidebar lock base 21, the sidebar lock base 21 is provided with a locking cavity 2102.

There are two large rear bar lock systems 3, the two large rear-bar lock systems 3 are set corresponding to the two side-bar lock systems 2, the large rear-bar lock system 3 includes a rear-bar lock block 31 and a lock connection shaft 32, the rear-bar lock block 31 is connected to the rear bar 4, the lock connection shaft 32 passes through the rear-bar lock block 31, one end of the lock connection shaft 32 is connected with a lock 3401 for mating with the lock cavity 2102, the other end of the lock connection shaft 32 is connected with a connector 3201 for connecting the wire rope 3501, the lock connection shaft 32 is provided with a spring 37, one end of the spring 37 is connected to the lock 3401, the other end of the spring 37 is connected to the rear bar lock block 31.

The interior of the rear bar lock block 31 is a step hole structure, the spring 37 comes to the step hole.

A plurality of the intermediate node blocks 36 are all connected to the rear bar 4, the wire rope 3501 passes through the intermediate node block 36, both ends of the wire rope 3501 are respectively connected to two connectors 3201.

By setting the wire rope 3501, users can pull the wire rope 3501 to pull the lock 3401 out of the lock cavity 2102, so as to open the rear bar 4; by setting up a plurality of intermediate node blocks 36 to separate the wire rope 3501 into several segments, so as to facilitate the user to pull the wire rope 3501.

The sidebar lock base 21 includes a slide-in groove 2101, the rear bar lock block 31 includes a block 3101 which is matches the slide-in groove 2101, the block 3101 is a cylinder.

The slide-in groove is a “√” shape.

The slide-in groove 2101 is provided with a limited protrusion at the end near rear-bar lock block 31, which is used to stop the block 3101.

By setting the slide-in groove 2101 and block 3101 the block 3101 can slide into the slip-in groove 2101 and snap in with the slip-in groove 2101.

When the user closes the lid to lock, the block 3101 of the rear-bar locking block 31 first falls into the slide-in groove 2101 on the first fixing block, the lock 3401 rotates at a certain angle with the cylindrical block 3101 as the lid is gradually closed, so that the lock 3401 is squeezed by the lock cavity 2102 and compressed into the inner ladder hole, ejected, and then snapped into the lock cavity 2102 to complete the closing operation of the car cover.

The connector 3201 is provided with an mounting hole for connecting the wire rope 3501.

The bed cover connection device includes two aluminum pressed wires 33, the two aluminum pressed wires 33 are located between the two connector 3201 which is corresponding to the two ends of the wire rope 3501 respectively, the aluminum pressed wire 33 is used to connect with the wire rope 3501.

By setting the mounting holes and aluminum pressed wire 33, the wire rope 3501 and the lock connection shaft 32 can be secured well to ensure the force strength.

The lock connection shaft 32 includes a threaded segment 3202 and a connection segment 3203, the lock 3401 is connected to the threaded segment 3202 by thread, the connection segment 3203 is provided with a fixed connector 3201.

The lock 3401 and the lock connection shaft 32 are fixed through threads, which not only ensures the strength of the connection of the lock 3401 but also facilitates the replacement of the lock 3401.

There are two intermediate node blocks 36, the intermediate node block 36 is provided with a cross-wire hole for passing through the wire rope 3501.

By setting two intermediate node blocks, the wire rope can be separated into three segments, which is convenient for users to pull.

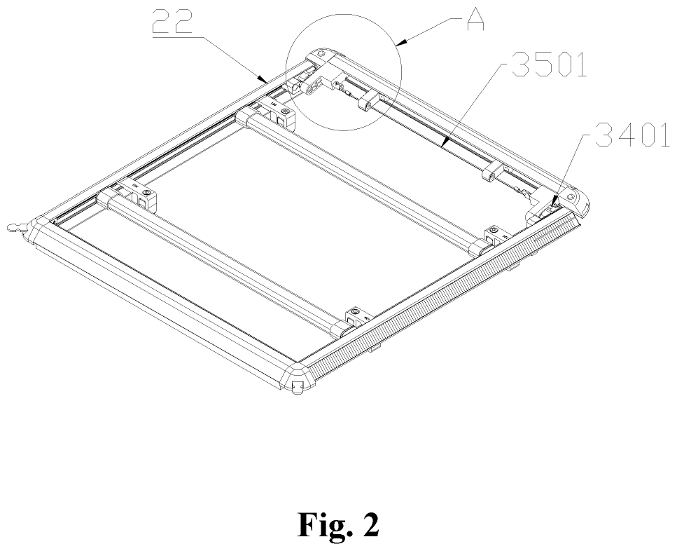

The outer upper surface of the locking cavity 2102 is oblique (the upper is referred to here as the upper side of FIG. 2), the inner upper surface of the locking cavity 2102 is flat, the end of the lock 3401 is curved.

The outer side of the lock cavity 2102 is designed as a bevel, so that it can produce a squeeze force on the lock 3401 when the lock touches the outer wall of the lock cavity 2102, so as to facilitate the locking of the bed cover. The inner side of the lock cavity 2102 is designed as a plane can effectively prevent the lock 3401 from sliding out.

When opening the bed cover, the user pulls the wire rope 3501 to pull the lock 3401 back into the ladder hole, and the user can lift the lid up to complete the opening operation of the car cover.

The bed cover connection device also includes a sidebar anti-tilting structure 2201 which is arranged above the sidebar 22 (above is referred to here as the upper side in actual using), the sidebar anti-tilting structure 2201 is used to prevent the sidebar 22 from tilting.

The sidebar anti-tilting structure 2201 is comprised of the bottom bulge point on the sidebar 22, which can form a fulcrum with the hard contact of the sidebar 22 to prevent the sidebar 22 from tilting.

### Detail Working Principle:

When the user closes the lid to lock, the block 3101 of the rear-bar locking block 31 first falls into the slide-in groove on the first fixing block, the lock:3401 rotates at a certain angle with the cylindrical block 3101 as the lid is gradually closed, so that the lock 3401 is squeezed by the lock cavity 2102 and compressed into the inner ladder hole, ejected, and then the snapped into the lock cavity 2102 to complete the closing operation of the car cover.

When opening the bed cover, the user pulls the wire rope 3501 to pull the lock 3401 back into the ladder hole by the lock connection shaft 32, and the user can lift the lid up to complete the opening operation of the car cover.

The above embodiment only to illustrate the technical scheme of the present invention, not to limit it. Although the present invention is described in detail by reference to the preceding embodiment, ordinary technical personnel in the art should understand that they may still modify the technical schemes recorded in the preceding embodiment, or replace some of the technical features with equivalents. The modifications or substitutions do not make the essence of the corresponding technical scheme separate from the spirit and scope of the technical scheme of each embodiment of the present invention.

The invention is not limited to the above-mentioned optional embodiment, anyone under the inspiration of the present invention can derive other forms of products. The above-mentioned specific embodiment shall not be understood as a limitation on the scope of protection of the present invention, the scope of protection of the present invention shall be defined in the claims, and the instructions may be used to explain the claim.

1. A bed cover connection device for pickup truck, wherein includes a sidebar lock system (2) which is connected to two sidebars (22), a large rear bar lock system (3) which is connected to the rear bar (4) and multiple intermediate node blocks (36);
the sidebar locking system (2) includes a sidebar lock base (21), the sidebar lock base (21) is provided with a locking cavity (2102),
there are two large rear bar lock systems (3), the two large rear-bar lock systems (3) are set corresponding to the two side-bar lock systems (2), the large rear-bar lock system (3) includes a rear-bar lock block (31) and a lock connection shaft (32), the rear-bar lock block (31) is connected to the rear bar (4), the lock connection shaft (32) passes through the rear-bar lock block (31), one end of the lock connection shaft (32) is connected with a lock (3401) matches the lock cavity (2102), the other end of the lock connection shaft (32) is connected with a connector (3201) for connecting the wire rope (3501), the lock connection shaft (32) is provided with a spring (37), one end of the spring (37) is connected to the lock (3401), the other end of the spring (37) is connected to the rear bar lock block (31);
A plurality of the intermediate node blocks (6) are all connected to the rear bar (4), the wire rope (3501) passes through the intermediate node block (36), both ends of the wire rope (3501) are respectively connected to two connection heads (3201).

2. A bed cover connection device according to claim 1, wherein, the sidebar lock base (21) includes a slide-in groove (2101), the rear bar lock block (31) includes a block (3101) which is matches the slide-in groove (2101), the block (3101) is a cylinder.

3. A bed cover connection device according to claim 2, wherein, the slide-in groove (21) is provided with a limited protrusion at the end (2101) near rear-bar lock block, which is used to stop the block (3101).

4. A bed cover connection device according to claim 1, wherein, the connector (3201) is provided with an mounting hole for connecting the wire rope (3501).

5. A bed cover connection device according to claim 4, wherein, it includes two aluminum pressed wires (33), the two aluminum pressed wires (33) are located between the two connector (3201) which is corresponding to the two ends of the wire rope (3501) respectively, the aluminum pressed wire (33) is used to connect with the wire rope (3501).

6. A bed cover connection device according to claim 1, wherein, the lock connection shaft (32) includes a threaded segment (3202) and a connection segment (3203), the lock (3401) is connected to the threaded segment (3202) by thread, the connection segment (3203) is provided with a fixed connector (3201).

7. A bed cover connection device according to claim 1, wherein, there are two intermediate node blocks (36), the intermediate node block (36) is provide with a cross-wire hole for crossing the wire rope (3501).

8. A bed cover connection device according to claim 6, wherein, the outer upper surface of the locking cavity (2102) is oblique, the inner upper surface of the locking cavity (2102) is flat, the end of the lock (3401) is curved.

9. A bed cover connection device according to claim 1, wherein, it includes a sidebar anti-tilt structure (2201) which is arranged above the sidebar (22), the sidebar anti-tilt structure (2201) is used to prevent the sidebar (22) from tilting.

10. A bed cover connection device according to claim 9, wherein, the sidebar anti-tilt structure (2201) is comprised of the bottom bulge point on the sidebar (22), which can form a fulcrum with the hard contact of the sidebar (22) to prevent the sidebar (22) from tilting.
